(19) United States
(12) Patent Application Publication
(10) Pub. No.: US 2026/0121801 A1
(43) Pub. Date: Apr. 30, 2026

(54) ASYMMETRIC RADIO LINK CONTROL PROTOCOL

(71) Applicant: Apple Inc., Cupertino, CA (US)

(72) Inventors: Panagiotis Botsinis, Munich (DE); Alperen Gundogan, Munich (DE); Sameh M. Eldessoki, Munich (DE); Tarik Tabet, Carlsbad, CA (US); Amr Abdelrahman Yousef Abdelrahman Mostafa, Munich (DE); Christian Hofmann, Munich (DE)

(21) Appl. No.: 19/372,119

(22) Filed: Oct. 28, 2025

(30) Foreign Application Priority Data
Oct. 31, 2024 (GR) 20240100764

(51) Int. Cl. H04L 1/1812; H04L 1/1867; H04W 28/02

(52) U.S. Cl. CPC H04L 1/1812; H04L 1/1874; H04W 28/0268

(57) ABSTRACT

The present disclosure generally relates to an asymmetric radio link control (RLC) protocol. One aspect of the present disclosure relates to a method that includes: receiving control signaling that configures at least one uplink RLC transmission parameter and at least one downlink RLC reception parameter for the asymmetric RLC protocol; transmitting an uplink packet using the at least one uplink RLC transmission parameter configured for the asymmetric RLC protocol; and receiving a downlink packet using the at least one downlink RLC reception parameter configured for the asymmetric RLC protocol.

### CROSS-REFERENCE TO RELATED APPLICATIONS

This application claims priority to Greek patent application No. 20240100764, filed Oct. 31, 2024, the entirety of which is incorporated herein by reference.

### TECHNICAL FIELD

This application relates generally to wireless communication, and more specifically to an asymmetric radio link control (RLC) protocol.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using one or more wireless network protocols, such as protocols described in various telecommunication standards promulgated by the ETSI Third Generation Partnership Project (3GPP). The wireless communication networks facilitate mobile broadband service using technologies such as orthogonal frequency-division multiple access (OFDMA), multiple input multiple output (MIMO), advanced channel coding, massive MIMO, beamforming, and/or other features.

### SUMMARY

One aspect of the present disclosure relates to a method including: receiving control signaling that configures one or more uplink radio link control (RLC) transmission parameters and at least one downlink RLC reception parameter for an asymmetric RLC protocol; transmitting an uplink packet using the at least one uplink RLC transmission parameter configured for the asymmetric RLC protocol; and receiving a downlink packet using the at least one downlink RLC reception parameter configured for the asymmetric RLC protocol.

Another aspect of the present disclosure relates to a method including: transmitting control signaling that configures at least one uplink RLC transmission parameter and at least one downlink RLC reception parameter for an asymmetric RLC protocol; receiving an uplink packet in accordance with the at least one uplink RLC transmission parameter configured for the asymmetric RLC protocol; and transmitting a downlink packet in accordance with the at least one downlink RLC reception parameter configured for the asymmetric RLC protocol.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates an example wireless network, according to some implementations.

FIG. 2A illustrates an example of a bi-directional radio link control (RLC) protocol, according to some implementations.

FIG. 2B illustrates an example of an asymmetric RLC protocol, according to some implementations.

FIG. 3A illustrates example RLC acknowledged mode (AM) packets, according to some implementations.

FIG. 3B illustrates example asymmetric RLC uplink (UL) packets, according to some implementations.

FIG. 4 illustrates an example of a logical channel mapping scheme, according to some implementations.

FIGS. 5 and 6 illustrate example RLC packet segmentation schemes, according to some implementations.

FIG. 7 illustrates an example of a HARQ transmission scheme, according to some implementations.

FIG. 8 illustrates example asymmetric RLC downlink (DL) packets, according to some implementations.

FIG. 9 illustrates an asymmetric RLC protocol, according to some implementations.

FIGS. 10 and 11 illustrate flowcharts of example methods, according to some implementations.

FIG. 12 illustrates an example user equipment (UE), according to some implementations.

FIG. 13 illustrates an example access node, according to some implementations.

### DETAILED DESCRIPTION

In wireless communications, the radio link control (RLC) layer helps to ensure reliable data transmission between a user equipment (UE) and the network. The RLC layer supports different operating modes, such as RLC acknowledged mode (AM), RLC unacknowledged mode (UM), and RLC transparent mode (TM). These modes offer varying levels of error control and retransmission mechanisms that are suitable for different types of applications and services. RLC AM is designed to provide reliable data transmission through error correction and retransmission. In RLC AM, the receiver sends an acknowledgment (ACK) for successfully delivered data packets and a negative acknowledgment (NACK) for lost or erroneous packets. The sender uses this feedback to perform retransmissions as needed. RLC UM is designed for scenarios where reliability is less critical, and low-latency transmission is preferred over retransmission. In RLC UM, ACK/NACK information is not returned to the sender, but RLC headers are still appended to enable buffering, segmentation, reordering, etc. In RLC TM, no headers or control information (such as sequence numbers or error detection codes) are added to the data, meaning the data is transmitted as-is, without any error correction, retransmission, or ACK/NACK feedback. The ACK/NACK feedback described herein refers to RLC status reports, which are separate from hybrid automatic repeat request (HARQ) feedback. HARQ ACK/NACK feedback is provided regardless of the RLC operating mode (e.g., RLC AM, RLC UM, or RLC TM), and HARQ retransmissions are scheduled as needed. HARQ retransmissions are mapped to the medium access control (MAC) layer.

RLC AM can be used to mitigate specific HARQ failures, such as NACK-to-ACK conversion errors and discontinuous transmission (DTX)-to-ACK conversion errors. NACK-to-ACK conversion errors can impact HARQ feedback for a downlink shared channel (DL-SCH), which is sent from a UE to a base station (BS). NACK-to-ACK conversion errors can arise when the BS decodes HARQ feedback as an ACK when the UE actually transmitted a NACK. DTX-to-ACK conversion errors can arise when the UE fails to receive a physical downlink control channel (PDCCH) scheduling the DL-SCH. In such cases, the UE does not provide any HARQ feedback, but the BS may still decode noise (or other received signals) as an ACK from the UE. In both scenarios, HARQ retransmissions are stopped because the BS erroneously concludes that the associated transmission has been successfully received, which can lead to a higher packet error rate (PER).

RLC AM can address these issues by allowing the sender to detect NACK-to-ACK conversion errors and DTX-to-ACK conversion errors using RLC status reports, a feature specific to RLC AM. For example, the RLC AM transmit entity of the sender (e.g., the BS) can use an RLC status report provided by the receiver (e.g., the UE) to determine which RLC service data units (SDUs) were successfully decoded by the receiver. Although RLC AM can help mitigate the foregoing conversion errors, which are exclusive to downlink reception, RLC UM may be more suitable for uplink communications (which are not affected by these issues). However, there is currently no way to leverage different RLC operating modes (such as AM and UM) for different communication links (such as downlink and uplink). RLC AM is bidirectional (e.g., symmetric) by definition, so if RLC AM is configured, both transmission directions (uplink and downlink) will use RLC AM, even if RLC AM is not needed for one of the links/directions. As such, the UE may have to support RLC AM for uplink and downlink, which can lead to higher signaling overhead and increased latency.

Aspects of the present disclosure generally relate to an asymmetric RLC protocol that can replace bi-directional RLC AM. At the UE side, this asymmetric RLC protocol includes a UM RLC entity for uplink transmission and an AM RLC entity for downlink reception. At the BS side, the asymmetric RLC protocol includes a UM RLC entity for uplink reception and an AM RLC entity for downlink transmission. Using the asymmetric RLC protocol described herein, both devices can leverage RLC AM for downlink operations and RLC UM for uplink operations, resulting in lower memory usage, reduced signaling overhead, lower power consumption, and reduced latency, among other benefits.

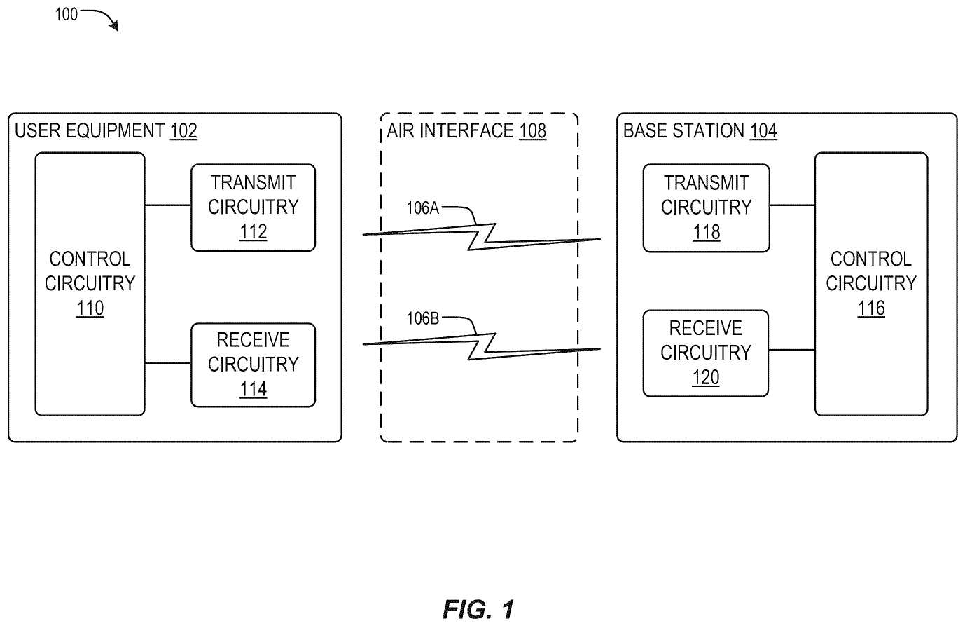

FIG. 1 illustrates an example wireless network 100, according to some implementations. The wireless network 100 includes a UE 102 and a BS 104 connected via one or more channels 106A, 106B across an air interface 108. The UE 102 and BS 104 communicate using a system that supports controls for managing the access of the UE 102 to a network via the BS 104.

In some implementations, the wireless network 100 is a Standalone (SA) network, e.g., that incorporates Fifth Generation (5G) New Radio (NR). In some other implementations, the wireless network 100 is a Non-Standalone (NSA) network that incorporates Long Term Evolution (LTE) and 5G NR. In these implementations, the wireless network 100 may be a E-UTRA (Evolved Universal Terrestrial Radio Access)-NR Dual Connectivity (EN-DC) network, or an NR-EUTRA Dual Connectivity (NE-DC) network. Furthermore, wireless networks implementing one or more other types of communication standards are possible, including future 3GPP systems (e.g., Sixth Generation (6G)), Institute of Electrical and Electronics Engineers (IEEE) 802.11 technology, or the like. While aspects may be described herein using terminology commonly associated with 5G NR, aspects of the present disclosure can be applied to other systems, such as systems subsequent to 5G (e.g., 6G).

In the wireless network 100, the UE 102 and any other UE in the system may be, for example, any of a laptop computer, smartphone, tablet computer, machine-type device (such as smart meters or specialized devices for healthcare), intelligent transportation system, or any other wireless device. In the wireless network 100, the BS 104 provides the UE 102 network connectivity to a broader network (not shown). This UE 102 connectivity is provided via the air interface 108 in a BS service area provided by the BS 104. In some implementations, such a broader network may be a wide area network operated by a cellular network provider, or may be the Internet. Each BS service area associated with the BS 104 is supported by one or more antennas integrated with the BS 104. The service areas can be divided into a number of sectors associated with one or more particular antennas. Such sectors may be physically associated with one or more fixed antennas or may be assigned to a physical area with one or more tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include application-specific circuitry, baseband circuitry, or any of various combinations thereof. The transmit circuitry 112 and receive circuitry 114 may be adapted to transmit and receive data, respectively, and may include radio frequency (RF) circuitry and/or front-end module (FEM) circuitry.

In various implementations, aspects of the transmit circuitry 112, receive circuitry 114, and/or control circuitry 110 may be integrated in various ways to implement the operations described herein. The control circuitry 110 may be adapted or configured to perform various operations, such as those described elsewhere in this disclosure related to a UE. For example, the control circuitry 110 can determine whether an uplink packet was successfully received based on a value of a new data indicator (NDI) field in a downlink control message.

The transmit circuitry 112 can perform various operations described herein. For example, the transmit circuitry 112 can transmit an uplink packet using an RLC UM mode in accordance with an asymmetric RLC protocol. Additionally, the transmit circuitry 112 may transmit using a plurality of multiplexed uplink physical channels. The plurality of uplink physical channels may be multiplexed, e.g., according to time division multiplexing (TDM) or frequency division multiplexing (FDM), and in some implementations, along with carrier aggregation. The transmit circuitry 112 may be configured to receive block data from the control circuitry 110 for transmission on the air interface 108.

The receive circuitry 114 can perform various operations described herein. For example, the receive circuitry 114 can receive a downlink packet using an RLC AM mode in accordance with the asymmetric RLC protocol. Additionally, the receive circuitry 114 may receive a plurality of multiplexed downlink physical channels from the air interface 108 and relay the physical channels to the control circuitry 110. The plurality of downlink physical channels may be multiplexed, e.g., according to TDM or FDM, e.g., along with carrier aggregation. The transmit circuitry 112 and the receive circuitry 114 may transmit and receive, respectively, both control data and content data (e.g., messages, images, video, etc.) structured within data blocks that are carried by the physical channels.

FIG. 1 also illustrates the BS 104. In some implementations, the BS 104 may be a 5G radio access network (RAN), a next generation RAN, a E-UTRAN, a non-terrestrial cell, or a legacy RAN, such as a UTRAN. As used herein, the term “5G RAN” or the like may refer to the BS 104 that operates in an NR wireless network 100, and the term “E-UTRAN” or the like may refer to a BS 104 that operates in an LTE wireless network 100. The UE 102 utilizes connections (or channels) 106A, 106B, each of which includes a physical communications interface or layer.

The BS 104 circuitry may include control circuitry 116 coupled (directly or indirectly) with transmit circuitry 118 and/or receive circuitry 120. The transmit circuitry 118 and receive circuitry 120 may each be coupled (directly or indirectly) with one or more antennas that may be used to enable communications via the air interface 108. The transmit circuitry 118 and receive circuitry 120 may be adapted to transmit and receive data, respectively, addressed to any UE connected to the BS 104. The receive circuitry 120 may receive a plurality of uplink physical channels from one or more UEs, including the UE 102.

In FIG. 1, the one or more channels 106A, 106B are illustrated as an air interface to enable communicative coupling, and can be consistent with cellular communications protocols, such as an LTE protocol, Advanced LTE (LTE-A) protocol, LTE-based access to unlicensed spectrum (LTE-U), NR protocol, NR-based access to unlicensed spectrum (NR-U) protocol, and/or any other communications protocol(s). In some implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Discovery Channel (PSDCH), and a Physical Sidelink Broadcast Channel (PSBCH).

It may be desirable for wireless systems (e.g., 5G-advanced, 6G or beyond) to have lower UE memory usage, lower latency, greater flexibility, and lower implementation complexity at the UE 102 and the BS 104. In 5G, RLC AM transmission (TX) is implemented at the UE 102, and transmitted RLC SDUs are stored at the RLC level. The UE 102 handles RLC status reports or polls for status information. The UE 102 also performs RLC retransmissions. The UE 102 can determine the importance of the uplink (UL) data that is mapped to a transport block (TB), but may be unable to determine whether that TB is correctly or erroneously received until the UE 102 receives an RLC status report from the BS 104. In 6G, the UE can operate without RLC AM TX, removing the need to (i) store data at the RLC level, (ii) handle RLC status reports, and/or (iii) perform RLC retransmissions.

In the UL of existing 5G systems, the BS 104 stops HARQ retransmissions at a specific time (regardless of reception status) and uses RLC AM reception (RX) entity to send a status report to the TX RLC AM entity (at the UE 102), which can add latency. The BS 104 may be unable to determine the importance of the UL data that is mapped to a TB prior to reception, but the BS 104 can determine whether the TB has been correctly or erroneously received. In 6G systems with asymmetric RLC, the UL can rely solely on HARQ retransmissions, which take place before RLC AM retransmissions. This can reduce the effective latency of feedback mechanisms. For data with higher reliability, additional HARQ retransmissions can be sent (and potentially in combination with MAC segmentation). After a HARQ failure, packet error(s) can propagate faster to higher layers (which can provide greater responsiveness).

In 5G systems with RLC AM configured, all packets have to be received. If RLC UM is configured, the BS 104 can determine how long to continue HARQ retransmissions. In 6G systems with asymmetric RLC (and potentially in combination with MAC segmentation), the BS 104 can dynamically choose whether to wait until a TB (or at least a portion of the TB) is successfully received, as with RLC AM, or skip the TB after a threshold number of retransmissions, as with RLC UM.

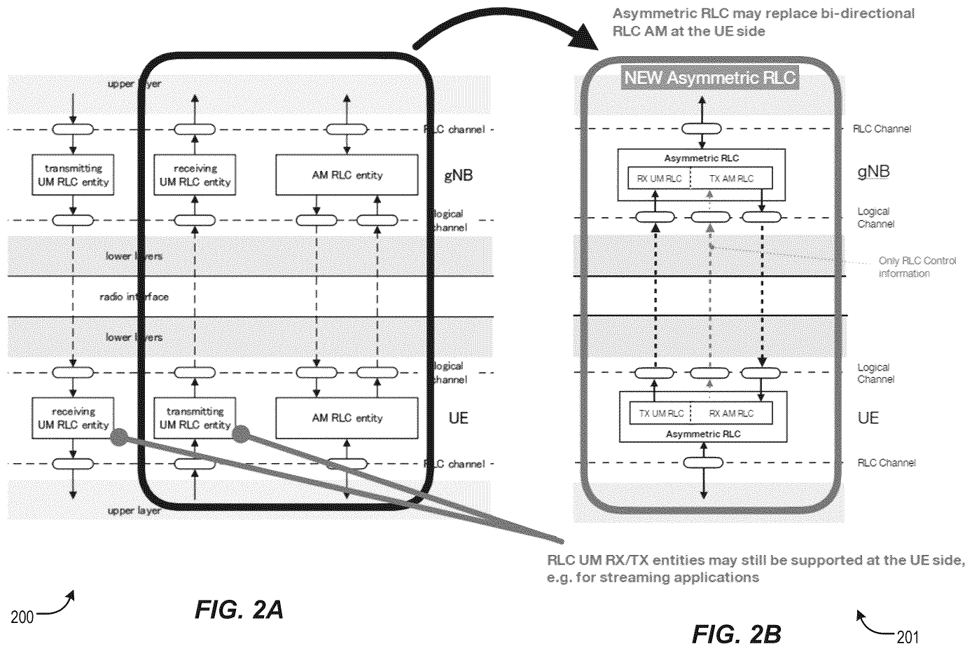

FIG. 2A illustrates an example of a bi-directional RLC protocol 200, according to some implementations. FIG. 2B illustrates an example of an asymmetric RLC protocol 201, according to some implementations. The asymmetric RLC protocol 201 (FIG. 2B) can replace bi-directional RLC AM (FIG. 2A) at the UE side. RLC UM RX/TX can still be supported at the UE side, e.g., for streaming applications. As shown in FIG. 2B, the asymmetric RLC protocol 201 manages the flow of information between logical channels and RLC channels. RLC control information can be mapped to a specific logical channel. On the UE side, the asymmetric RLC protocol 201 includes a TX UM RLC entity and an RX AM RLC entity. On the gNB side, the asymmetric RLC protocol 201 includes an RX UM RLC entity and a TX AM RLC entity.

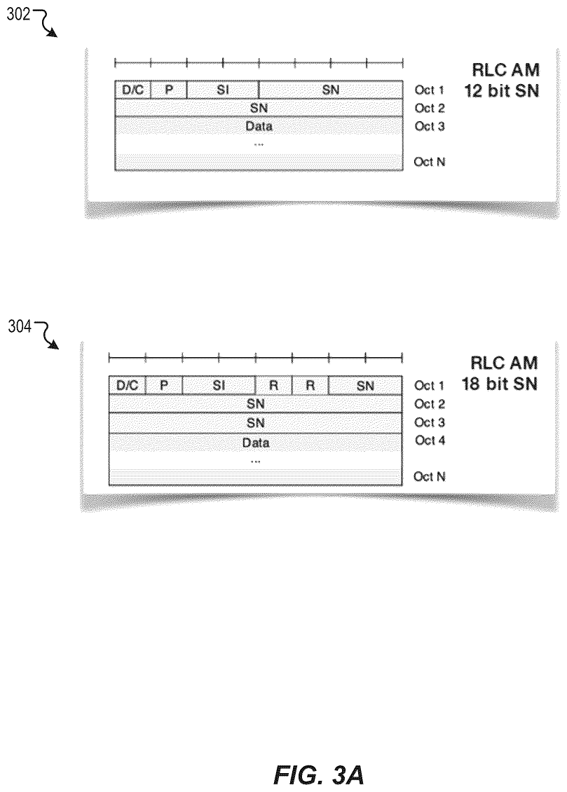

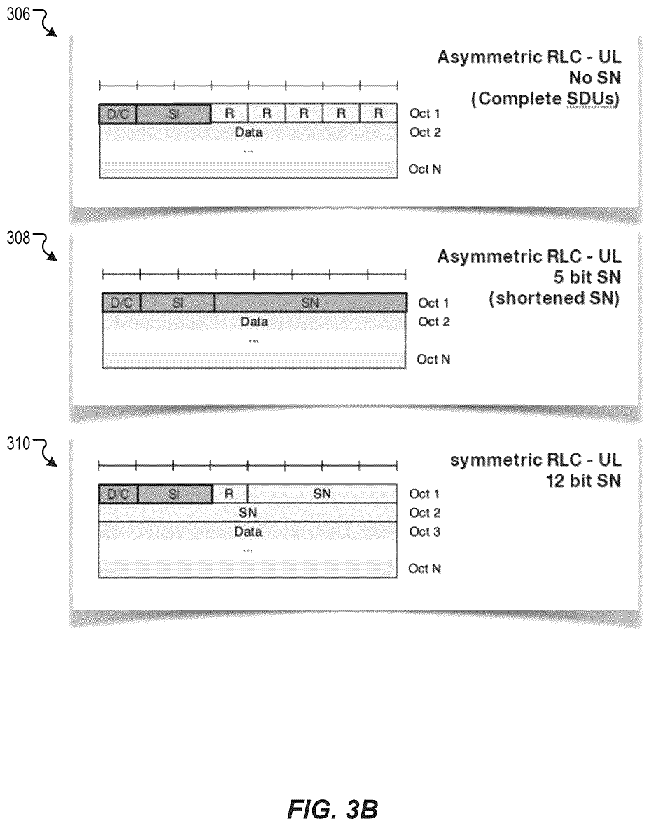

FIG. 3A illustrates an example of an RLC AM packet 302 with a 12 bit sequence number (SN) and an RLC AM packet 304 with an 18 bit SN, according to some implementations. The RLC AM packet 302 and the RLC AM packet 304 both include a data/control (D/C) field to indicate whether the packet includes data or control information. The RLC AM packet 302 and the RLC AM packet 304 also include a sequence indicator (SI) field to indicate whether the packet includes a complete RLC SDU or the first, middle, or last segment of an RLC SDU.

FIG. 3B illustrates an example of an asymmetric RLC UL packet 306 with complete SDUs and no SN, an asymmetric RLC UL packet 308 with a 5 bit shortened SN, and an asymmetric RLC UL packet 310 with a 12 bit SN, according to some implementations. The example data packets depicted in FIG. 3B each include (i) a D/C field to indicate whether the packet includes data or control information and (ii) an SI field to indicate whether the packet includes a complete RLC SDU or the first, middle, or last segment of an RLC SDU.

For UL asymmetric RLC, no polling is performed from the UE side. Specifically, t-PollRetransmit is not included, as TX RLC UM does not poll for the status of UL traffic. Also, no Poll-bit is included in the packet header. The D/C field can be used to indicate the status of DL traffic. In some implementations, independent SN ranges can be configured for UL and DL, resulting in a smaller SN size for UL compared to DL. Most use cases have DL/UL asymmetry, where DL throughput is higher than UL throughput.

In line with RLC UM, complete segments (packets) do not use SNs, which are specifically for segments. The TX window at the UE does not have to span a relatively long period of time either, as ARQ feedback is not expected. HARQ feedback, which is received earlier, can move the TX window. The RX window at the BS can be shorter, resulting in lower reassembly/reordering buffer constraints. Retransmission handling/buffering and/or RLC status reception handling may not be implemented at the UE side.

The asymmetric RLC UL packet formats depicted in FIG. 3B may result in lower memory usage at UE and BS, greater over-the-air signaling efficiency, reduced header overhead (1-2 bytes saved per complete packet relative to RLC AM), reduced processing power at the UE side, and reduced UL latency, among other benefits.

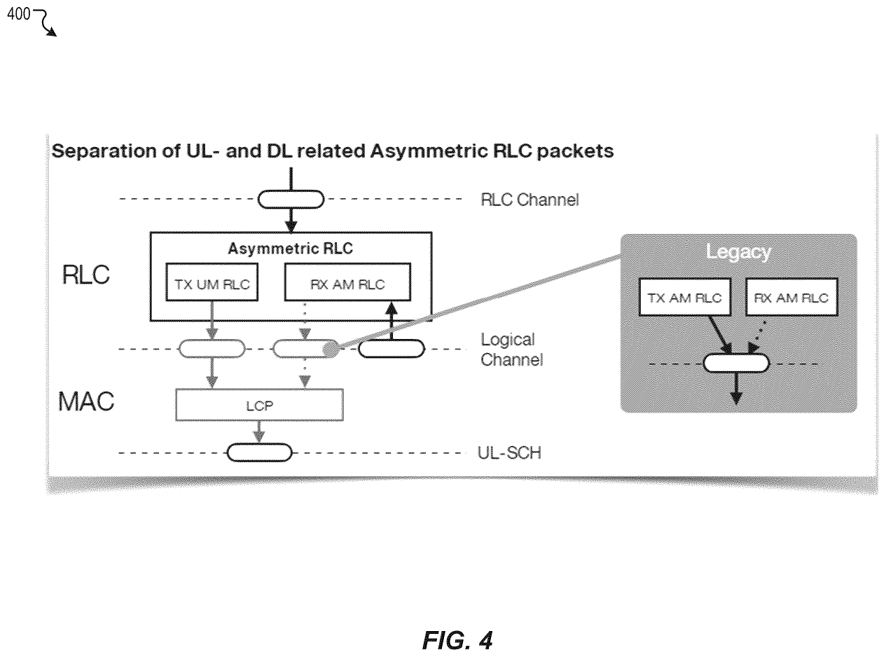

FIG. 4 illustrates an example of a logical channel mapping scheme 400, according to some implementations. The example logical channel mapping scheme 400 depicted in FIG. 4 shows the separation of control information and data in UL as well as the separation between UL and DL-related asymmetric RLC packets. To make UL and DL data independent (and to allow for prioritization of data vs. control information), asymmetric RLC UL data (similar to RLC UM) and asymmetric RLC UL control information (related to DL Data) can be mapped to different logical channels to allow for differentiation within the Logical Channel Prioritization (LCP) entity of the UE's MAC layer. This way, the UE can prioritize either the RLC UL control information or the RLC UL data via an appropriate LCP configuration. If control information related to a DL data stream is included in a UL TB and the MAC/PHY layer is aware (e.g., if separate logical channel identifiers (LCIDs) are configured), the reliability of the transmission (or a portion thereof) can be increased.

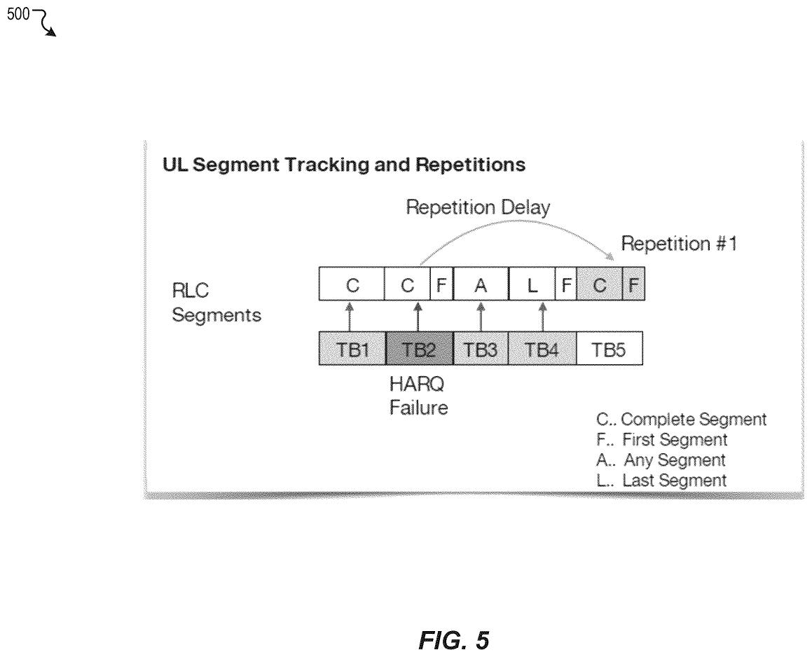

FIG. 5 illustrates an example RLC packet segmentation scheme 500, according to some implementations. The example RLC packet segmentation scheme 500 depicted in FIG. 5 can be used for UL segment tracking and repetition. In accordance with aspects of the present disclosure, a UL entity can track which HARQ process an RLC segment belongs to and whether a TB from that HARQ process was successfully received. After receiving an indication (from lower layers) that a specific HARQ process has failed, the UL entity may repeat affected segments in the next transmission. This way, the UL entity can selectively repeat relevant/important segments. The number of repetitions and the time at which a repetition is triggered (immediately vs. delayed) can be configured by the network.

One advantage of this selective repetition at the RLC level, apart from increasing the number of HARQ retransmissions, is that the BS is not aware of the importance of the content in the failed TB. In some cases, the TB may include a combination of different RLC entities, such as asymmetric and UM, so the BS may be unable to dynamically increase the reliability of specific TBs. On the UL TX side, the UE can decide whether to repeat PDUs of specific RLC entities. Compared to RLC AM, the asymmetric RLC protocol disclosed herein may support smaller TX buffers, since UL data is buffered for a shorter duration (e.g., a few HARQ retransmissions). Also, there is no need for RLC status reporting over the air.

In some implementations, lower layer feedback that the original transmission or HARQ retransmission(s) have failed can be based on a new data indicator (NDI) field, which is provided in DCI via PDCCH. The UE and BS can jointly decide how frequently the NDI bit remains untoggled (e.g., how many HARQ retransmissions are allowed). If this threshold is exceeded, it means this particular HARQ process has failed, and HARQ retransmissions should be stopped. An NDI value of e.g., 0->0->0->0->0 in consecutive packets can indicate that (i) the last UL packet was not successfully received by the network and (ii) the UE should send new UL data. An NDI value of e.g., 0->0->0->0->1 in consecutive packets can indicate that (i) the last UL packet was successfully received by the network and (ii) the UE should send new UL data. The term “new UL data” encompasses data that is being transmitted for the first time and data that is being retransmitted again. Alternatively, ACK/NACK feedback for UL transmissions can be introduced, e.g., as a new DCI field in PDCCH or as a separate channel that is used in addition to (or instead of) DCI with NDI, after the BS decides that the last retransmission attempt has been made.

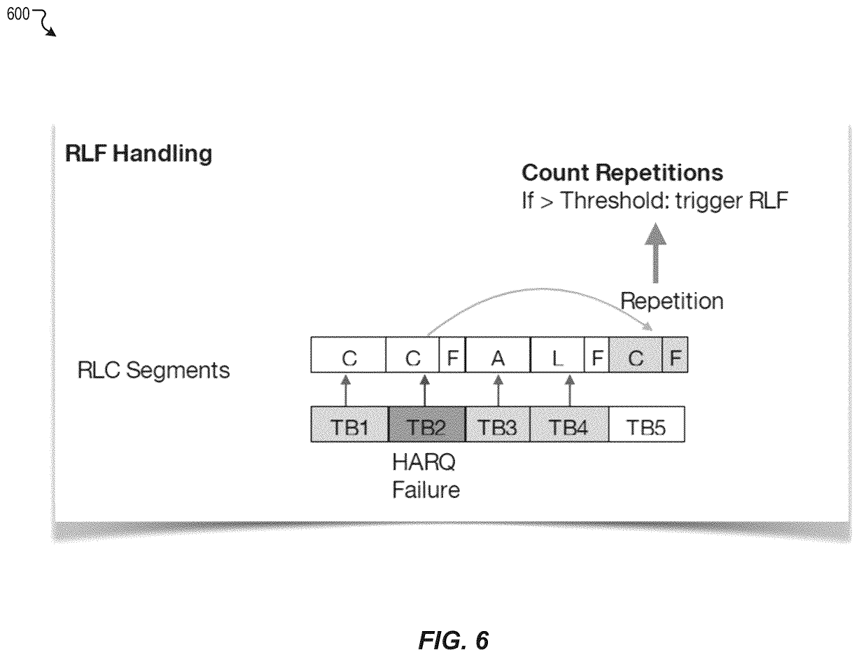

FIG. 6 illustrates an example RLC packet segmentation scheme 600, according to some implementations. The example RLC packet segmentation scheme 600 depicted in FIG. 6 can be used for RLC blind repetition and UL radio link failure (RLF). In some implementations, the asymmetric RLC layer disclosed herein can perform repetitions of RLC PDUs in multiple HARQ processes to ensure that RLC information reaches the BS. For example, if HARQ process #1 uses multiple retransmissions, the information duplicated in another process may reach the BS faster. Blind repetitions can be activated for UL data (as with RLC UM TX) and UL control information (e.g., DL-related ARQ feedback) independently. The example RLC packet segmentation scheme 600 depicted in FIG. 6 is not limited to the asymmetric RLC protocol described herein, and can also be implemented with the 5G RLC protocol.

The RLC packet segmentation scheme 600 may support new triggers for RLF on the UE side (compared to the BS side that receives RLC feedback). Without ARQ or segment tracking (as shown and described with reference to FIG. 5), the UE may be unable to detect if a UL connection has an issue. Accordingly, new DL control signaling can be introduced to allow RLF detection on the UE side, e.g., a DCI or MAC CE. Additionally, or alternatively, the BS may configure a maximum HARQ retransmission threshold or a maximum number of MAC segmentations. In such cases, the UE can observe such criteria and when the threshold is reached, RLF can be triggered on the UE side. With UL segment tracking, RLF can be detected via an RRC-configured threshold or timer that tracks the number of segment repetitions. After the threshold or timer expires, RLF can be declared. Combined with different LCIDs for control information and data, different thresholds can be defined for DL and UL-related transmissions.

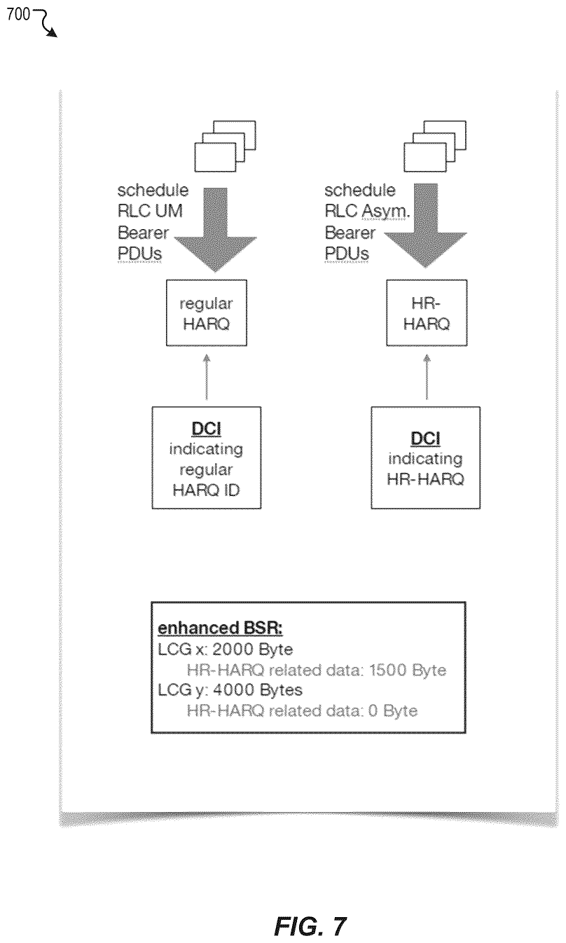

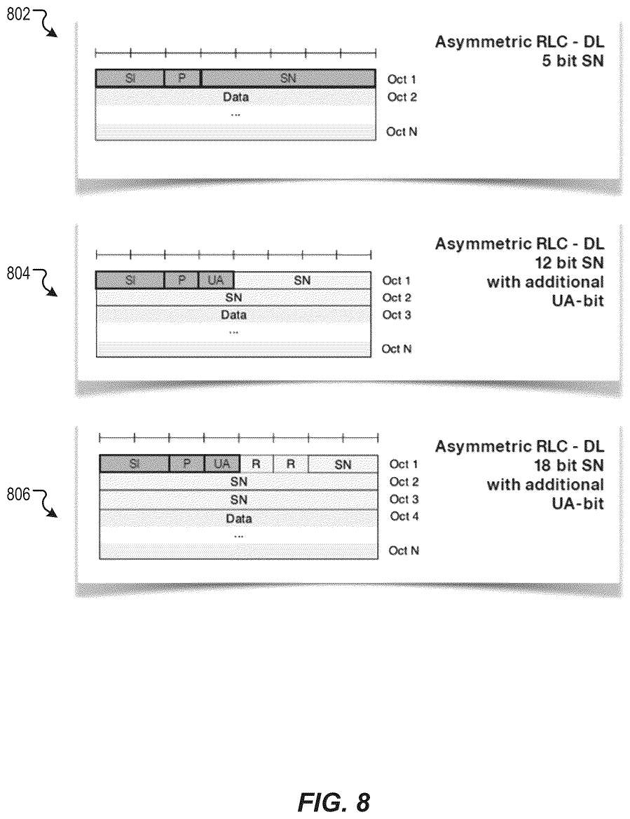

FIG. 7 illustrates an example of a HARQ transmission scheme 700 for UL high reliability HARQ, according to some implementations. Some aspects of the present disclosure allow the UE/BS to selectively increase the reliability of specific asymmetric RLC PDUs in UL or asymmetric RLC PDUs vs. other RLC UM PDUs without changing the HARQ configuration or overall performance. Alternatively, this process can be controlled by the BS, which would mean increasing the reliability of the HARQ feedback itself, depending on what kind of data was in the TB, e.g., by increasing the number of HARQ retransmissions for TBs that include more important RLC data.

Since the BS may be unable to determine the content of a TB before decoding it, specific RLC channels can be mapped to High Reliability HARQ (HR-HARQ) process IDs, e.g., via RRC configuration. For HR-HARQ IDs, the BS can use a higher number of retransmissions, while using fewer retransmissions for other HARQ IDs. To promote more efficient resources usage, buffer status reports (BSRs) can be updated to indicate the amount of data pending for transmissions with HR-HARQ IDs. This can be accomplished by adding a new IE in the BSR (as shown in FIG. 7) or by configuring an HR-LCG that includes the relevant RLC channels.

FIG. 8 illustrates an example of an asymmetric RLC DL packet 802 with a 5-bit SN, an asymmetric RLC DL packet 804 with a 12-bit SN and an additional uplink alive (UA) bit, and an asymmetric RLC DL packet 806 with an 18-bit SN and an additional UA bit, according to some implementations. The packet structure of the asymmetric RLC DL packet 802 may provide a 1 byte saving per packet (compared to AM 12 bit SN). For asymmetric RLC, DL carries AM-like DL data (e.g., DL data that is conveyed using an RLC AM packet structure), but no feedback for the UL channel. RLC status transmission handling is not used at the BS side. Also, t-StatusProhibit is not used at the BS (as the UL has no feedback), and there a D/C flag is not included in the header.

With asymmetric RLC, there is no ARQ feedback provided to the UE, so if the UL direction fails or deteriorates, the UE may still be able to decode DCI from the BS, but UL transmissions from the UE may not reach the BS. Apart from the previously mentioned HARQ failure detection mechanism, the UE may be unaware of the UL status. In some implementations, a new UA flag in the DL header of RLC DL PDUs (or a new MAC CE) can be provided from the BS to the UE. If the UA flag is set to 1, the BS is receiving UL and the RLC connection is operational. If the UA flag is set to 0, the BS is experiencing issues with the UL, and the UE can trigger RLF based on this indication.

The UA flag may be set to 0 if, for example, the decoding rate of UL TBs drops below X %, or if the last Y consecutively scheduled UL transmissions of the same HARQ process or multiple HARQ processes have failed. Additionally, or alternatively, the UA flag can be set to 0 if a counter for poll-bits sent without receiving a status report reaches a threshold X, indicating that X status reports have been lost.

Poll-bit tracking can be used on the TX side (for DL TX from BS to UE). In 5G systems, upon reception of a poll-bit, the RLC RX entity of the UE triggers an RLC status report (t-StatusProhibit is also considered). The RLC TX entity on the BS side has multiple triggers defined for when to send a poll-bit to request an RLC status report. These triggers include (i) PDU_WITHOUT_POLL, (ii) BYTE_WITHOUT_POLL and (iii) no new RLC SDU can be transmitted (e.g., TX window stalling, TX/ReTX buffer running empty). The poll-bit transmission/retransmission logic is based on when the poll-bit is sent and the RLC TX entity starts t-PollRetransmit. This can be triggered after expiry of t-PollRetransmit.

The techniques described herein support new functionality on the TX side for poll-bit tracking. The RLC TX entity at the BS tracks the number of poll-bits set without receiving an RLC Status Report. This process also considers t-StatusProhibit at the UE side. As an example, if a poll-bit was sent N times and no RLC status report was received within a period of (N*t-StatusProhibit timer duration), there may be an issue. Alternatively, the BS can start a timer at the RLC level when a polling bit is sent. If an RLC status report is received, the BS stops the timer. If the timer expires, the BS sets the UA bit to false (0) and sends the resulting DCI to the UE.

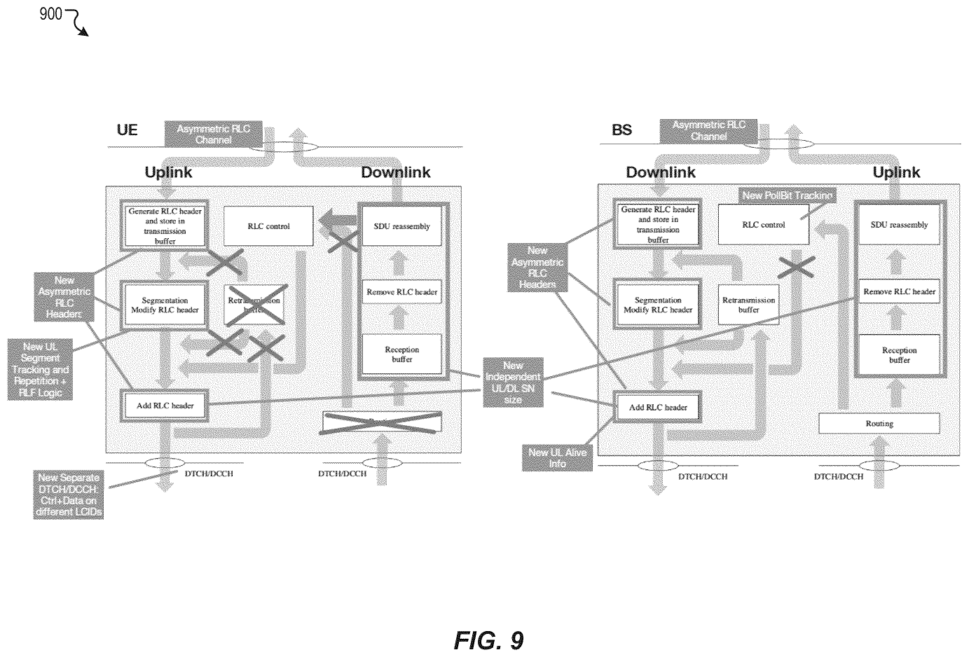

FIG. 9 illustrates an asymmetric RLC protocol 900, according to some implementations. The example asymmetric RLC protocol 900 depicted in FIG. 9 shows the updated flow of UL and DL at the UE and BS when using asymmetric RLC instead of 5G RLC AM. There is no RLC AM TX entity at the UE, so DL routing can be omitted because there is no need for RLC status handling, as retransmissions of UL packets are not required. Additionally, there is no need for retransmission buffers to keep TX RLC PDUs (for retransmission purposes). On the network side, the BS does not have to send RLC status reports, so some DL RLC control processes can be omitted.

In some implementations, parameters of the asymmetric RLC protocol 900 may be configured via an RRC configuration. The asymmetric RLC protocol 900 may leverage aspects of RLC UM for UL and aspects of RLC AM for DL. The asymmetric RLC protocol 900 may have independent SN sizes. The UE may still support unidirectional RLC UM, e.g., for live video streaming. The asymmetric RLC protocol 900 may use 2 logical channel LCIDs, one for control information and one for data of the same RLC channel. Since the control of RLC retransmission and RLC status polling is managed by the BS, the configuration of the asymmetric RLC protocol 900 can be simplified (relative to UL RLC AM). For example, maxRetxThreshold, pollPDU, and pollByte may not be configured at the UE side. Independent SN ranges can be configured for UL and DL. A large SN size may be configured for DL to enable high throughput, and a small SN size may be configured for UL to reduce per packet overhead. The asymmetric RLC protocol 900 can also include an optional UL segment tracking configuration. An example configuration for the asymmetric RLC protocol 900 is listed below:

RLC-BearerConfig ::= SEQUENCE {

| logicalChannelIdentity | LogicalChannelIdentity, | |
|---|---|---|
| logicalChannelIdentityCtrl | LogicalChannelIdentity, | |
| servedRadioBearer | CHOICE { | |
| srb-Identity | SRB-Identity, | |
| drb-Identity | DRB-Identity | |
| } | | OPTIONAL, -- Cond LCH-SetupOnly |
| reestablishRLC | ENUMERATED {true} | OPTIONAL, -- Need N |
| rlc-Config | RLC-Config | OPTIONAL, -- Cond LCH-Setup |
| mac-LogicalChannelConfig | LogicalChannelConfig | OPTIONAL, -- Cond LCH-Setup |
| mac-LogicalChannelConfigCtrl | LogicalChannelConfig | OPTIONAL, -- Cond LCH-Setup |

| | |
|---|---|
| ul-SegmentTrackingConfig | UL-Segment-Tracking-Config OPTIONAL, -- Cond LCH- |

```
  Setup
    ...
  }
  RLC-Config ::= CHOICE {
    ...
```

| | |
|---|---|
| asymmetric | SEQUENCE { |
| ul-UM-RLC | Asymmetric-UL-UM-RLC, |
| dl-AM-RLC | Asymmetric-DL-AM-RLC |

```
    },
    ...
  }
  Asymmetric-UL-UM-RLC ::= SEQUENCE {
```

| | | |
|---|---|---|
| sn-FieldLength | SN-FieldLengthAsymmetricUL | OPTIONAL -- Cond Reestab |

```
  }
  Asymmetric-DL-AM-RLC ::= SEQUENCE {
```

| | | |
|---|---|---|
| sn-FieldLength | SN-FieldLengthAsymmetricDL | OPTIONAL, -- Cond Reestab |

| | |
|---|---|
| t-Reassembly | T-Reassembly, |
| t-StatusProhibit | T-StatusProhibit |

```
  }
  SN-FieldLengthUM ::= ENUMERATED {size6, size12}
  SN-FieldLengthAM ::= ENUMERATED {size 12, size18}
  SN-FieldLengthAsymmetricUL ::= ENUMERATED {size5, size12}
  SN-FieldLengthAsymmetricDL ::= ENUMERATED {size5, size12, size18}
  UL-Segment-Tracking-Config ::= SEQUENCE {
    maxNumberOfRepetitionsUntilRLF ::= {0, 2, 4, 6, ...}
    repetitionDelayInSlots := {0, 1, 2, 3, ...}
  }
```

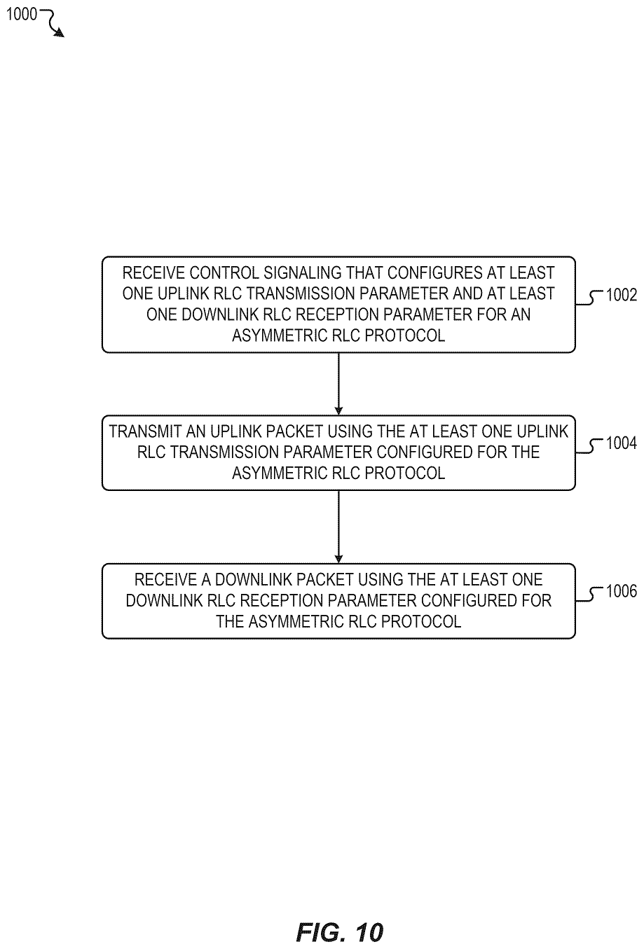

FIG. 10 illustrates a flowchart of an example method 1000, according to some implementations. For clarity of presentation, the method 1000 is generally described in the context of the preceding figures. For example, the method 1000 can be performed by the UE 102 of FIG. 1, or by any suitable system, environment, software, hardware, or combination thereof. In some implementations, operations of the method 1000 can be run in parallel, in combination, in loops, or in any order. The example method 1000 shown in FIG. 10 can be modified or reconfigured to include additional, fewer, or different steps (not shown in FIG. 10), which can be performed in the order shown or in a different order.

At 1002, the method 1000 includes receiving control signaling that configures at least one uplink RLC transmission parameter and at least one downlink RLC reception parameter for an asymmetric RLC protocol.

At 1004, the method 1000 includes transmitting an uplink packet using the at least one uplink RLC transmission parameter configured for the asymmetric RLC protocol.

At 1006, the method 1000 includes receiving a downlink packet using the at least one downlink RLC reception parameter configured for the asymmetric RLC protocol.

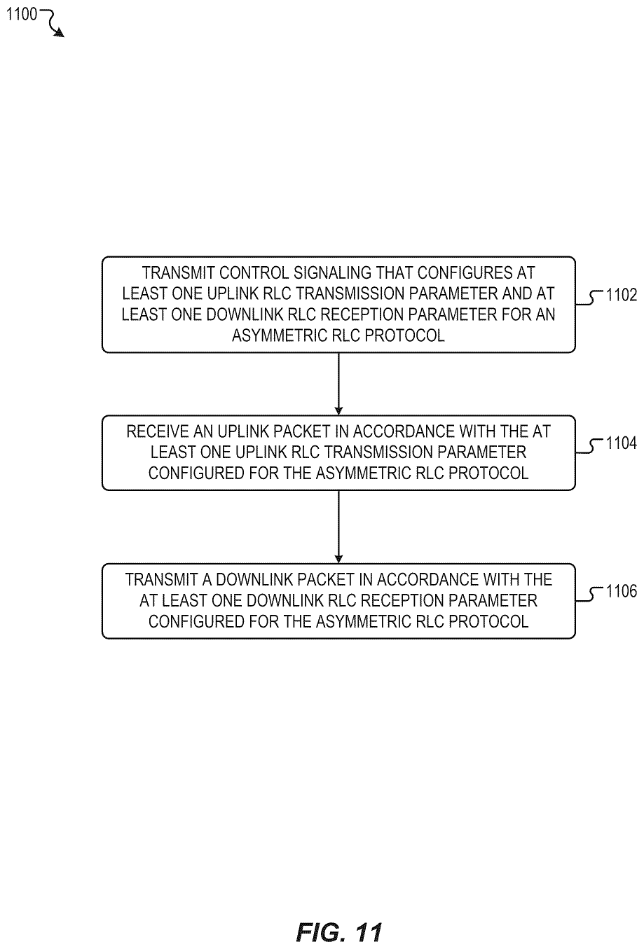

FIG. 11 illustrates a flowchart of an example method 1100, according to some implementations. For clarity of presentation, the method 1100 is generally described in the context of the preceding figures. For example, the method 1100 can be performed by the UE 102 of FIG. 1, or by any suitable system, environment, software, hardware, or combination thereof. In some implementations, operations of the method 1100 can be run in parallel, in combination, in loops, or in any order. The example method 1100 shown in FIG. 11 can be modified or reconfigured to include additional, fewer, or different steps (not shown in FIG. 11), which can be performed in the order shown or in a different order.

At 1102, the method 1100 includes transmitting control signaling that configures at least one uplink RLC transmission parameter and at least one downlink RLC reception parameter for an asymmetric RLC protocol.

At 1104, the method 1100 includes receiving an uplink packet in accordance with the at least one uplink RLC transmission parameter configured for the asymmetric RLC protocol.

At 1106, the method 1100 includes transmitting a downlink packet in accordance with the at least one downlink RLC reception parameter configured for the asymmetric RLC protocol.

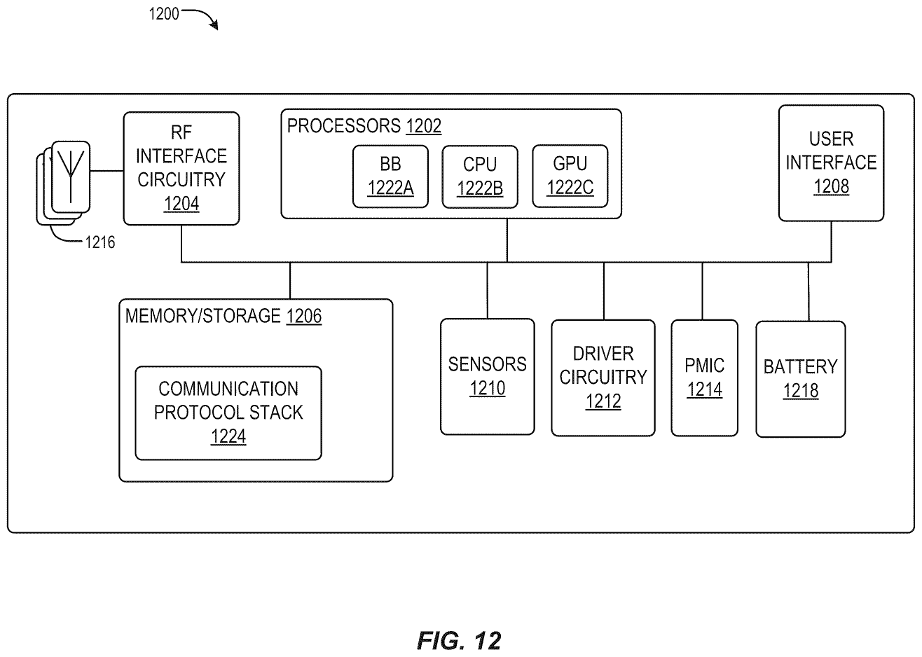

FIG. 12 illustrates an example UE 1200, according to some implementations. The UE 1200 may be similar to and substantially interchangeable with the UE 102 of FIG. 1. The UE 1200 may be any mobile or non-mobile computing device, such as, for example, a mobile phone, computer, tablet, industrial wireless sensors, video device (for example, cameras, video cameras, etc.), wearable devices (for example, a smart watch), relaxed-IoT devices, etc.

The UE 1200 may include any/all of processor 1202, RF interface circuitry 1204, memory/storage 1206, user interface 1208, sensors 1210, driver circuitry 1212, power management integrated circuit (PMIC) 1214, one or more antenna(s) 1216, and battery 1218. The components of the UE 1200 may be implemented as integrated circuits (ICs), portions thereof, discrete electronic devices, or other modules, logic, hardware, software, firmware, or a combination thereof. The block diagram of FIG. 12 is intended to show a high-level view of some of the components of the UE 1200. However, some of the components shown may be omitted, additional components may be present, and a different arrangement of the components shown may occur in other implementations.

The components of the UE 1200 may be coupled with various other components over one or more interconnects 1220, which may represent any type of interface, input/output, bus (local, system, or expansion), transmission line, trace, optical connection, etc., that allows various circuit components (on common or different chips or chipsets) to interact with one another.

The processor 1202 may include one or more processors. For example, the processor 1202 may include processor circuitry such as, for example, baseband processor circuitry (BB) 1222A, central processor unit circuitry (CPU) 1222B, and graphics processor unit circuitry (GPU) 1222C. The processor 1202 may include any type of circuitry or processor circuitry that executes or otherwise operates computer-executable instructions, such as program code, software modules, or functional processes from memory/storage 1206 to cause the UE 1200 to perform operations as described herein.

In some implementations, the baseband processor circuitry 1222A may access a communication protocol stack 1224 in the memory/storage 1206 to communicate over a 3GPP compatible network. In general, the baseband processor circuitry 1222A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 1204. The baseband processor circuitry 1222A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 1206 may include one or more non-transitory, computer-readable media that includes instructions (for example, communication protocol stack 1224) that may be executed by the processor 1202 to cause the UE 1200 to perform various operations described herein. The memory/storage 1206 include any type of volatile or non-volatile memory that may be distributed throughout the UE 1200. In some implementations, some of the memory/storage 1206 may be located on the processor 1202 itself (for example, L1 and L2 cache), while other memory/storage 1206 is external to the processor 1202 but accessible thereto via a memory interface. The memory/storage 1206 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1204 may include transceiver circuitry and radio frequency front module (RFEM) that allows the UE 1200 to communicate with other devices over a radio access network. The RF interface circuitry 1204 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna(s) 1216 and proceed to filter and amplify (with a low-noise amplifier) the signal. The signal may be provided to a receiver of the transceiver that downconverts the RF signal into a baseband signal that is provided to the baseband processor.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 1216. In various implementations, the RF interface circuitry 1204 may be configured to transmit/receive signals in a manner compatible with NR access technologies.

The antenna(s) 1216 may include one or more antenna elements to convert electrical signals into radio waves to travel through the air and to convert received radio waves over the air into electrical signals. In some implementations, the antenna elements may be arranged into one or more antenna panels. The antenna(s) 1216 may have antenna panels that are omnidirectional, directional, or a combination thereof, to enable beamforming and multiple input, multiple output communications. The antenna(s) 1216 may include any/all of microstrip antennas, printed antennas fabricated on the surface of one or more printed circuit boards, patch antennas, phased array antennas, etc. The antenna(s) 1216 may have one or more panels designed for one or more specific frequency bands, such as bands in FR1 or FR2.

The user interface 1208 includes various input/output (I/O) devices designed to enable user interaction with the UE 1200. The user interface 1208 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 1200.

The sensors 1210 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1212 may include software and hardware elements that operate to control particular devices that are embedded in the UE 1200, attached to the UE 1200, or otherwise communicatively coupled with the UE 1200. The driver circuitry 1212 may include individual drivers allowing other components to interact with or control various input/output (I/O) devices that may be present within, or connected to, the UE 1200. For example, driver circuitry 1212 may include a display driver to control and allow access to a display device, a touchscreen driver to control and allow access to a touchscreen interface, sensor drivers to obtain sensor readings of sensors 1210 and control and allow access to sensors 1210, drivers to obtain actuator positions of electro-mechanic components or control and allow access to the electro-mechanic components, a camera driver to control and allow access to an embedded image capture device, audio drivers to control and allow access to one or more audio devices.

The PMIC 1214 may manage power provided to various components of the UE 1200. In particular, with respect to the processor 1202, the PMIC 1214 may control power-source selection, voltage scaling, battery charging, or DC-to-DC conversion.

In some implementations, the PMIC 1214 may control, or otherwise be part of, various power saving mechanisms of the UE 1200. A battery 1218 may power the UE 1200, although in some examples the UE 1200 may be mounted deployed in a fixed location, and may have a power supply coupled to an electrical grid. The battery 1218 may be a lithium ion battery, a metal-air battery, such as a zinc-air battery, an aluminum-air battery, a lithium-air battery, and the like. In some implementations, such as in vehicle-based applications, the battery 1218 may be a typical lead-acid automotive battery.

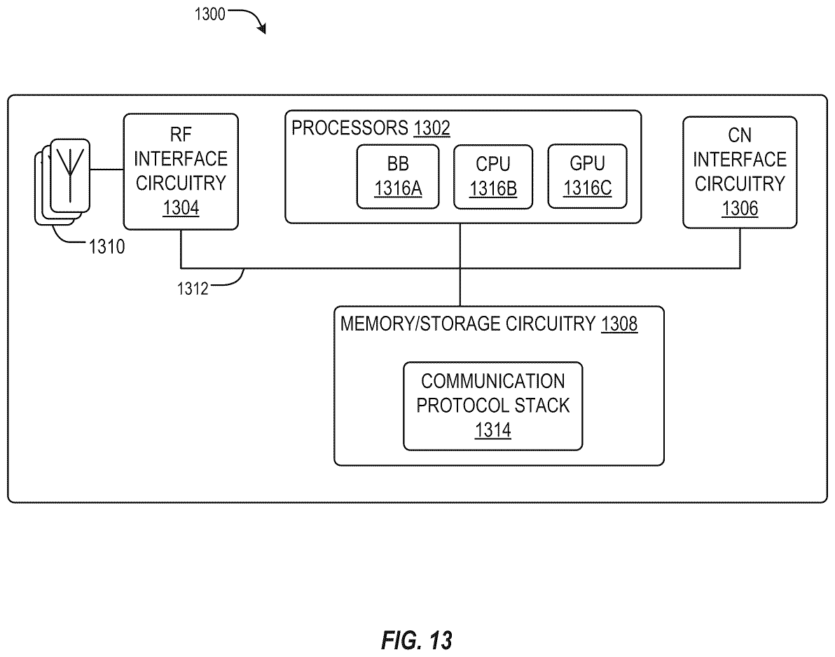

FIG. 13 illustrates an example access node 1300 (e.g., a BS or gNB), according to some implementations. The access node 1300 may be similar to and substantially interchangeable with BS 104. The access node 1300 may include one or more of processor 1302, RF interface circuitry 1304, core network (CN) interface circuitry 1306, memory/storage circuitry 1308, and one or more antenna(s) 1310. The processor 1302 may include any type of circuitry or processor circuitry that executes or otherwise operates computer-executable instructions, such as program code, software modules, or functional processes from memory/storage circuitry 1308 to cause the access node 1300 to perform operations as described herein.

The components of the access node 1300 may be coupled with various other components over one or more interconnects 1312. The processor 1302, RF interface circuitry 1304, memory/storage circuitry 1308 (including communication protocol stack 1314), antenna(s) 1310, and interconnects 1312 may be similar to like-named elements shown and described with respect to FIG. 12. For example, the processor 1302 may include processor circuitry such as, for example, baseband processor circuitry (BB) 1316A, central processor unit circuitry (CPU) 1316B, and graphics processor unit circuitry (GPU) 1316C.

The CN interface circuitry 1306 may provide connectivity to a core network, for example, a 5th Generation Core network (5GC) using a 5GC-compatible network interface protocol such as carrier Ethernet protocols, or some other suitable protocol. Network connectivity may be provided to/from the access node 1300 via a fiber optic or wireless backhaul. The CN interface circuitry 1306 may include one or more dedicated processors or FPGAs to communicate using one or more of the aforementioned protocols. In some implementations, the CN interface circuitry 1306 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 1300 that operates in an NR or 5G system (for example, a gNB), and the term “E-UTRAN node” or the like may refer to an access node 1300 that operates in an LTE or 4G system (e.g., an eNB). According to various implementations, the access node 1300 may be implemented as one or more of a dedicated physical device such as a macrocell BS, and/or a low power (LP) BS for providing femtocells, picocells or other like cells having smaller coverage areas, smaller user capacity, or higher bandwidth compared to macrocells.

In some implementations, all or parts of the access node 1300 may be implemented as one or more software entities running on server computers as part of a virtual network, which may be referred to as a CRAN and/or a virtual baseband unit pool (vBBUP). In V2X scenarios, the access node 1300 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, BS, network element, etc., as described above in connection with one or more of the preceding figures may be configured to operate in accordance with one or more of the examples set forth below in the example section.

Example 1 is a method including: receiving control signaling that configures at least one uplink RLC transmission parameter and at least one downlink RLC reception parameter for an asymmetric RLC protocol; transmitting an uplink packet using the at least one uplink RLC transmission parameter configured for the asymmetric RLC protocol; and receiving a downlink packet using the at least one downlink RLC reception parameter configured for the asymmetric RLC protocol.

Example 2 includes the method of example 1, where at least one status polling field is omitted from a header of the uplink packet.

Example 3 includes the method of any of examples 1 to 2, where a header of the uplink packet includes a D/C field to indicate whether the uplink packet includes uplink data or control information.

Example 4 includes the method of any of examples 1 to 3, where receiving the control signaling includes receiving RRC signaling that independently configures respective SN ranges for uplink RLC packets and downlink RLC packets.

Example 5 includes the method of any of examples 1 to 4, further including mapping RLC uplink data to a first logical channel and RLC uplink control information to a second logical channel in accordance with the at least one uplink RLC transmission parameter configured for the asymmetric RLC protocol.

Example 6 includes the method of example 5, further including assigning different priority levels to the first logical channel and the second logical channel corresponding to a transmission priority of the RLC uplink data or the RLC uplink control information.

Example 7 includes the method of any of examples 1 to 6, further including adjusting a transmission reliability of the uplink packet based on (i) an LCID associated with the uplink packet and (ii) whether the uplink packet includes control information associated with a downlink data stream.

Example 8 includes the method of any of examples 1 to 7, further including determining whether to retransmit a segment of the uplink packet based at least on (i) a priority of the segment and (ii) a reception status of the segment.

Example 9 includes the method of any of examples 1 to 8, further including: receiving DCI that includes an NDI field; and determining whether a segment of the uplink packet was successfully received based at least on a current value of the NDI field and a previous value of the NDI field.

Example 10 includes the method of any of examples 1 to 9, where outputting the uplink packet includes repeating at least a portion of the uplink packet in two or more HARQ processes in accordance with a blind repetition scheme configured for the asymmetric RLC protocol.

Example 11 includes the method of example 10, where the blind repetition scheme is separately activated for uplink data and uplink control information.

Example 12 includes the method of any of examples 10 to 11, further including declaring RLF based at least on a maximum HARQ retransmission threshold or a maximum number of MAC segments configured for the asymmetric RLC protocol.

Example 13 includes the method of any of examples 10 to 12, further including declaring RLF based at least on a threshold or timer that corresponds to a number of uplink segment repetitions, where the threshold or timer is configured by the control signaling.

Example 14 includes the method of any of examples 1 to 13, further including mapping an RLC channel to a HARQ process ID based on a priority of uplink data associated with the RLC channel, where the uplink packet includes the uplink data that is mapped to the HARQ process ID.

Example 15 includes the method of example 14, where a maximum number of HARQ retransmissions for the uplink packet is based at least on the HARQ process ID associated with the uplink data.

Example 16 includes the method of any of examples 14 to 15, further including outputting a BSR that indicates an amount of pending uplink data associated with the HARQ process ID of the uplink packet.

Example 17 includes the method of any of examples 1 to 16, where an uplink status field in a header of the downlink packet indicates a status of an uplink connection between a UE and a BS.

Example 18 includes the method of example 17, further including declaring RLF based at least on a value of the uplink status field in the header of the downlink packet.

Example 19 includes the method of any of examples 17 to 18, where a value of the uplink status field is based at least on an uplink TB decoding rate, a consecutive number of failed uplink transmissions associated with one or more HARQ processes, or a number of poll bits sent without receipt of an RLC status report.

Example 20 includes the method of any of examples 1 to 19, where the at least one uplink RLC transmission parameter and the at least one downlink RLC reception parameter include at least one of a logical channel identity configuration, an uplink segment tracking configuration, an asymmetric uplink RLC UM configuration, an asymmetric downlink RLC AM configuration, an asymmetric uplink SN field length, or an asymmetric downlink SN field length.

Example 21 includes the method of any of examples 1 to 20, where the at least one uplink RLC transmission parameter are associated with an RLC UM and the at least one downlink RLC reception parameter are associated with an RLC AM.

Example 22 includes the method of any of examples 1 to 21, where the control signaling configures a first LCID for control information associated with an RLC channel and a second LCID for data associated with the RLC channel.

Example 23 is an apparatus including: one or more processors; and memory storing instructions that, when executed, cause the one or more processors to perform the method of any of examples 1-22.

Example 24 is a UE including at least one processor configured to perform the method of any of examples 1-22.

Example 25 is a baseband processor configured to perform the method of any of examples 1-22.

Example 26 is a method including: outputting control signaling that configures at least one uplink RLC transmission parameter and at least one downlink RLC reception parameter for an asymmetric RLC protocol; receiving an uplink packet in accordance with the at least one uplink RLC transmission parameter configured for the asymmetric RLC protocol; and transmitting a downlink packet in accordance with the at least one downlink RLC reception parameter configured for the asymmetric RLC protocol.

Example 27 includes the method of example 26, further including increasing a number of HARQ retransmissions for the uplink packet based on a HARQ process ID associated with the uplink packet.

Example 28 includes the method of any of examples 26 to 27, further including starting a timer after sending a polling bit for an RLC status report.

Example 29 includes the method of example 28, further including stopping the timer after receiving the RLC status report in response to the polling bit.

Example 30 includes the method of any of examples 28 to 29, further including setting an uplink status field in a header of the downlink packet to a first value upon expiration of the timer, the first value indicating a status of an uplink connection between a UE and a BS.

Example 31 is an apparatus including: one or more processors; and memory storing instructions that, when executed, cause the one or more processors to perform the method of any of examples 26-30.

Example 32 is a BS including at least one processor configured to perform the method of any of examples 26-30.

Example 33 is a baseband processor configured to perform the method of any of examples 26-30.

Any of the foregoing examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

As described above, one aspect of the present technology may relate to the gathering and use of data available from specific and legitimate sources to allow for interaction with a second device for a data transfer. The present disclosure contemplates that in some examples, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used to provide for secure data transfers occurring between a first device and a second device. The personal information data may further be utilized for identifying an account associated with the user from a service provider for completing a data transfer.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any requisite steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For example, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. For example, a user may “opt in” or “opt out” of having information associated with an account of the user stored on a user device and/or shared by the user device. In addition to providing “opt in” and “opt out” options, the present disclosure contemplates providing notifications relating to the access or use of personal information. For example, a user may be notified upon downloading an application that their personal information data will be accessed and then reminded again just before personal information data is accessed by the application. In some examples, the user may be notified upon initiation of a data transfer of the device accessing information associated with the account of the user and/or the sharing of information associated with the account of the user with another device.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without accessing such personal information data. That is, the various embodiments of the present technology are not rendered inoperable due to the lack of all or a portion of such personal information data. For example, content can be selected and delivered to users based on aggregated non-personal information data or a bare minimum amount of personal information, such as the content being handled only on the user's device or other non-personal information available to the content delivery services.

We claim:

1. A method comprising:
receiving control signaling that configures at least one uplink radio link control (RLC) transmission parameter and at least one downlink RLC reception parameter for an asymmetric radio link control (RLC) protocol;
transmitting an uplink packet using the at least one uplink RLC transmission parameter configured for the asymmetric RLC protocol; and
receiving a downlink packet using the at least one downlink RLC reception parameter configured for the asymmetric RLC protocol.

2. The method of claim 1, wherein at least one status polling field is omitted from a header of the uplink packet.

3. The method of claim 1, wherein a header of the uplink packet comprises a data/control (D/C) field to indicate whether the uplink packet comprises uplink data or control information.

4. The method of claim 1, wherein receiving the control signaling comprises receiving radio resource control (RRC) signaling that independently configures respective sequence number (SN) ranges for uplink RLC packets and downlink RLC packets.

5. The method of claim 1, further comprising mapping RLC uplink data to a first logical channel and RLC uplink control information to a second logical channel in accordance with the at least one uplink RLC transmission parameter configured for the asymmetric RLC protocol.

6. The method of claim 5, further comprising assigning different priority levels to the first logical channel and the second logical channel corresponding to a transmission priority of the RLC uplink data or the RLC uplink control information.

7. The method of claim 1, further comprising adjusting a transmission reliability of the uplink packet based at least in part on (i) a logical channel identifier (LCID) associated with the uplink packet and (ii) whether the uplink packet includes control information associated with a downlink data stream.

8. The method of claim 1, further comprising determining whether to retransmit a segment of the uplink packet based at least on (i) a priority of the segment and (ii) a reception status of the segment.

9. The method of claim 1, further comprising:
receiving downlink control information (DCI) that includes a new data indicator (NDI) field; and
determining whether a segment of the uplink packet was successfully received based at least on a current value of the NDI field and a previous value of the NDI field.

10. The method of claim 1, wherein outputting the uplink packet comprises repeating at least a portion of the uplink packet in two or more hybrid automatic repeat request (HARQ) processes in accordance with a blind repetition scheme configured for the asymmetric RLC protocol.

11. The method of claim 10, wherein the blind repetition scheme is separately activated for uplink data and uplink control information.

12. The method of claim 10, further comprising declaring radio link failure (RLF) based at least on a maximum hybrid automatic repeat request (HARQ) retransmission threshold or a maximum number of medium access control (MAC) segments configured for the asymmetric RLC protocol.

13. The method of claim 10, further comprising declaring radio link failure (RLF) based at least on a threshold or timer that corresponds to a number of uplink segment repetitions, wherein the threshold or timer is configured by the control signaling.

14. The method of claim 1, further comprising mapping an RLC channel to a hybrid automatic repeat request (HARQ) process identifier (ID) based at least in part on a priority of uplink data associated with the RLC channel, wherein the uplink packet comprises the uplink data that is mapped to the HARQ process ID.

15. The method of claim 14, wherein a maximum number of HARQ retransmissions for the uplink packet is based at least on the HARQ process ID associated with the uplink data.

16. The method of claim 14, further comprising outputting a buffer status report (BSR) that indicates an amount of pending uplink data associated with the HARQ process ID of the uplink packet.

17. A method comprising:
transmitting control signaling that configures at least one uplink radio link control (RLC) transmission parameter and at least one downlink RLC reception parameter for an asymmetric RLC protocol;
receiving an uplink packet in accordance with the at least one uplink RLC transmission parameter configured for the asymmetric RLC protocol; and
transmitting a downlink packet in accordance with the at least one downlink RLC reception parameter configured for the asymmetric RLC protocol.

18. The method of claim 17, further comprising increasing a number of hybrid automatic repeat request (HARQ) retransmissions for the uplink packet based at least in part on a HARQ process ID associated with the uplink packet.

19. The method of claim 17, further comprising starting a timer after sending a polling bit for an RLC status report.

20. An apparatus comprising:
one or more processors; and
memory storing instructions that, when executed, cause the one or more processors to perform operations comprising:
receiving control signaling that configures at least one uplink radio link control (RLC) transmission parameter and at least one downlink RLC reception parameter for an asymmetric radio link control (RLC) protocol;
transmitting an uplink packet using the at least one uplink RLC transmission parameter configured for the asymmetric RLC protocol; and
receiving a downlink packet using the at least one downlink RLC reception parameter configured for the asymmetric RLC protocol.
